(19) United States
(12) Patent Application Publication
(10) Pub. No.: US 2016/0307267 A1
(43) Pub. Date: Oct. 20, 2016

(54) Alerting Method For Assisting User in Performing Disciplined Operations in Security Trading

(71) Applicant: Fonestock Technology Inc., Taipei (TW)

(72) Inventors: Chu Tsung Chen, Taipei City (TW); Yi Hsuan Kuo, Taipei (TW)

(73) Assignee: Fonestock Technology Inc., Taipei (TW)

(21) Appl. No.: 15/098,517

(22) Filed: Apr. 14, 2016

(30) Foreign Application Priority Data
Apr. 16, 2015 (TW) 104112287

(51) Int. Cl. G06Q 40/04; G06Q 40/08

(52) U.S. Cl. CPC G06Q 40/04; G06Q 40/08

(57) ABSTRACT

An alerting method which actively alerts the user if the trading he/she is making fulfills a predetermined trading strategy is disclosed. This method firstly determines an alerting condition of a security in a client device. The alerting condition is associated with a disciplined operating rule. The client device then accesses a historical trading record of the security, and calculates a prime cost of the security based on the record. When the user uses the client device to perform a trading of the security, and inputs a volume and a price of the security, and then, according to the alerting condition and the prime cost of the security, the client device determines whether or not the input volume and price fulfills the disciplined operating rule defined by the alerting condition, so as to display an alerting message on the client device based on the result of determination.

This application claims the benefit of Taiwan Patent Application Serial No. 104112287, filed Apr. 16, 2015, the subject matter of which is incorporated herein by reference.

### BACKGROUND OF INVENTION

1. Field of the Invention

The invention relates to a an alerting method for assisting user in performing disciplined operations in security trading, and more particularly to the alerting method that can actively alert the user whether or not the trading he/she is making fulfills a predetermined trading strategy while the user is performing operations for trading securities.

2. Description of the Prior Art

As information technology progress, people express their special needs in real-time and convenient information accessibility and their desires in advanced communicative devices. Various new multi-functional portable wireless communication devices are presented to the marketplace in an unprecedented fashion and an astonished speed, and all of which are simply to meet versatile and quick-changing demands. These communication devices includes various cellular phones, smart phones, devices with real-time stock info function, personal digital assistants, tablet calculators, notebook calculators, and any electronic device with wireless communication function.

Except for the aforesaid wireless communication devices, various software and apps are provided to those devices so as further to satisfy users in manifolds of convenience, real-time communication, in-time financing, jobs, entertainments, information accessing and so on. For example, specific wireless communication devices have facilitated the electronic trading for exchanging stocks, futures and the like valuable securities. The electronic service provided by the aforesaid devices can include the order-placing and more significantly the information sourcing of security trading information for helping the user to judge a prospective security and to also determine the trade timing for his/her own valuable securities.

Currently, though specific computer software are developed by some service providers to assist the user in evaluating the trends of the concerned securities or in determining relevant trade timing or price for the concerned securities, yet a real-time warning provided right to an in-process security trading for alerting the user whether or not his/her instant security trading fulfills relevant trading strategy, whether or not more sale/buy shall be considered, or/and whether the instant trade is high risked and thus shall be abandoned is never possible to these computer software. Thus, improvement upon the aforesaid software is definitely necessary.

### SUMMARY OF THE INVENTION

Accordingly, it is the primary object of the present invention to provide an alerting method for assisting user in performing disciplined operations in security trading. The alerting method, mainly applied to a security information processing system, can help the user devoting himself/herself to performing operations in security trading to be actively alerted whether or not the trading he/she is making fulfills a predetermined trading strategy, whether or not more sale/buy shall be considered, or/and whether the instant trade is high risked and thus shall be abandoned, and thereby the user's operations would be biased from his/her preset trading strategy in security trading.

In the present invention, the alerting method for assisting user in performing disciplined operations in security trading, applied to a security information processing system including a server and at least one client device, the server capturing a plurality of trading information of a plurality of securities from a foreign information source and storing the plurality of trading information into a database, the at least one client device being able to be used to perform an electronic trade or a simulated trade (the trade) upon the securities; the alerting method comprising the steps of:

Step (A): Configuring at least one alerting condition of at least one said security in the client device, the alerting condition being associated with a disciplined operating rule, the client device reading a historical trading record relative to the security, according to the historical trading record to calculate a prime cost of the security; wherein the configuring of the at least one alerting condition is achieved by operating the client device to perform setup or to recall the preset alerting condition stored in the client device;

Step (B): Operating the client device to perform the trade upon the security, and inputting a volume and a price of the security to be traded; and

Step (C): After the volume and the price of the security to be traded are set up, and before the trade is seriously performed, the client device basing on the configured alerting condition of the security and the calculated prime cost to determine whether the input volume and price of the security meet a disciplined operating rule defined by the alerting condition, and then basing on a result of the determining to generate an alerting message to be displayed on a screen of the client device so as to help a user to perform related disciplined operations.

In one embodiment of the present invention, the disciplined operating rule includes a trade rule of selling high but keeping low. Namely, for the same security to be electronically traded at various timing, if a clearance is not considered, the security with positions having higher buy-in prices shall be sold firstly, and the security with positions at lower buy-in prices should be kept in positions.

In one embodiment of the present invention, in the Step (C), the alerting message further includes one of following two steps:

(Step (C1): when the electronic trade is to sell the security and the result of the determining confirms that the disciplined operations are met, the alerting message to be displayed including:

If sale price>prime cost of current sale volume,
displaying “in this position of sale, profits realized are positive”;

If sale price>prime cost of current open-position volume,
displaying “after this sale, unrealized profits in positions are positive”; and

If the aforesaid two conditions are met simultaneously,
displaying additionally “Your buy strategy basically satisfies the price-raising rule”; and

Step (C2): when the electronic trade is to sell the security and the result of the determining confirms that the disciplined operations are not met, the alerting message to be displayed including:

If sale price<prime cost of current sale volume,
displaying “in this position of sale, profits realized are negative, and more sale shall be considered”, and simultaneously a functional button “more sale” being displayed below the alerting message;

If sale price<prime cost of current open-position volume,
displaying “after this sale, unrealized profits in positions are negative, and a clearance shall be considered”, and simultaneously a functional button “clearance” being displayed below the alerting message he alerting message; clicking the “clearance” functional button leading directly to display a volume in positions;

If the aforesaid two conditions are met simultaneously,
displaying additionally “Your buy strategy is a downward amortization, a high-risk operation”.

In one embodiment of the present invention, the disciplined operating rule includes a stop gain/stop loss calculation rule with respect to the security, the stop gain/stop loss calculation rule including the following algorithms:

algorithms 1: stop gain price=prime cost×stop interest, wherein the stop interest is a preset value of 1.15;

algorithms 2: stop price=prime cost×loss ratio, wherein the loss ratio is a preset value of 0.92;

and, wherein the alerting method includes a daily auto-calibration process upon the stop gain/stop loss calculation rule, the daily auto-calibration process including:
calibration rule 1: when close price of the security≧stop gain price of the security,
   if the close price×loss ratio≧previous stop price, the daily stop price of the security=close price×loss ratio;
   if the close price×loss ratio<previous stop price, the daily stop price of the security being kept unchanged;
calibration rule 2: as the daily stop price is updated,
   if the daily stop price>stop gain price, updating the daily stop gain price=stop price, namely the stop gain price and the stop price being the same;

wherein the alerting method displays the updated stop gain price and stop price on the screen of the client device.

In one embodiment of the present invention, the disciplined operating rule includes a risk exposure amount calculation rule with respect to the security, the risk exposure amount calculation rule including the following algorithms:
calibration rule 3: when the current price of the security≧stop price,
   If prime cost≧stop price, then risk exposure amount=prime cost−stop price; and
   If prime cost<stop price, then risk exposure amount=0;
calibration rule 4: when the current price of the security<stop price,
   If current price<prime cost×loss ratio, then risk exposure amount=prime cost−current price; and
   If current price≧prime cost×loss ratio, then risk exposure amount=prime cost−prime cost×loss ratio;

wherein the stop price is obtained according to the daily auto-calibration process upon the stop gain/stop loss calculation rule;

wherein the alerting method displays the calculated risk exposure amount on the screen of the client device.

In one embodiment of the present invention, calibration rule 3: when the current price of the security≧stop price,
If prime cost≧stop price, then risk exposure amount=prime cost−stop price; and
If prime cost<stop price, then risk exposure amount=0; and
calibration rule 4: when the current price of the security<stop price,
   If current price<prime cost×loss ratio, then risk exposure amount=prime cost−current price; and
   If current price≧prime cost×loss ratio, then risk exposure amount=prime cost−prime cost×loss ratio;

wherein the stop price is obtained according to the daily auto-calibration process upon the stop gain/stop loss calculation rule;

wherein the alerting method displays the calculated risk exposure amount on the screen of the client device.

All these objects are achieved by the alerting method for assisting user in performing disciplined operations in security trading described below.

### BRIEF DESCRIPTION OF THE DRAWINGS

The present invention will now be specified with reference to its preferred embodiment illustrated in the drawings, in which:

FIG. 1 shows schematically an embodiment of a security information processing system for performing an alerting method for assisting user in performing disciplined operations in security trading in accordance with the preset invention;

FIG. 2 is a flowchart of an embodiment of the alerting method for assisting user in performing disciplined operations in security trading in accordance with the present invention;

FIG. 3 demonstrates a first embodiment of a display on the screen of the client device in the alerting method for assisting user in performing disciplined operations in security trading in accordance with the present invention;

FIG. 4 demonstrates a second embodiment of a display on the screen of the client device in the alerting method for assisting user in performing disciplined operations in security trading in accordance with the present invention;

FIG. 5 is a flowchart of a process of information receiving and alerting for the alerting method for assisting user in performing disciplined operations in security trading in accordance with the present invention;

FIG. 6 is a flowchart of a process of user's operations for the alerting method for assisting user in performing disciplined operations in security trading in accordance with the present invention;

FIG. 7A and FIG. 7B are integrally as a flowchart of a process of window reformatting for the alerting method for assisting user in performing disciplined operations in security trading in accordance with the present invention;

FIG. 8 demonstrates a third embodiment of a display on the screen of the client device in the alerting method for assisting user in performing disciplined operations in security trading in accordance with the present invention;

FIG. 9 demonstrates a fourth embodiment of a display on the screen of the client device in the alerting method for assisting user in performing disciplined operations in security trading in accordance with the present invention;

FIG. 10 demonstrates a fifth embodiment of a display on the screen of the client device in the alerting method for assisting user in performing disciplined operations in security trading in accordance with the present invention;

FIG. 11 demonstrates a sixth embodiment of a display on the screen of the client device in the alerting method for assisting user in performing disciplined operations in security trading in accordance with the present invention;

FIG. 12 demonstrates a seventh embodiment of a display on the screen of the client device in the alerting method for assisting user in performing disciplined operations in security trading in accordance with the present invention;

FIG. 13 demonstrates an eighth embodiment of a display on the screen of the client device in the alerting method for assisting user in performing disciplined operations in security trading in accordance with the present invention;

FIG. 14 demonstrates a ninth embodiment of a display on the screen of the client device in the alerting method for assisting user in performing disciplined operations in security trading in accordance with the present invention;

FIG. 15 demonstrates a tenth embodiment of a display on the screen of the client device in the alerting method for assisting user in performing disciplined operations in security trading in accordance with the present invention;

FIG. 16 demonstrates an eleventh embodiment of a display on the screen of the client device in the alerting method for assisting user in performing disciplined operations in security trading in accordance with the present invention;

FIG. 17 demonstrates a twelfth embodiment of a display on the screen of the client device in the alerting method for assisting user in performing disciplined operations in security trading in accordance with the present invention;

FIG. 18 demonstrates a thirteenth embodiment of a display on the screen of the client device in the alerting method for assisting user in performing disciplined operations in security trading in accordance with the present invention; and

FIG. 19 demonstrates a fourteenth embodiment of a display on the screen of the client device in the alerting method for assisting user in performing disciplined operations in security trading in accordance with the present invention.

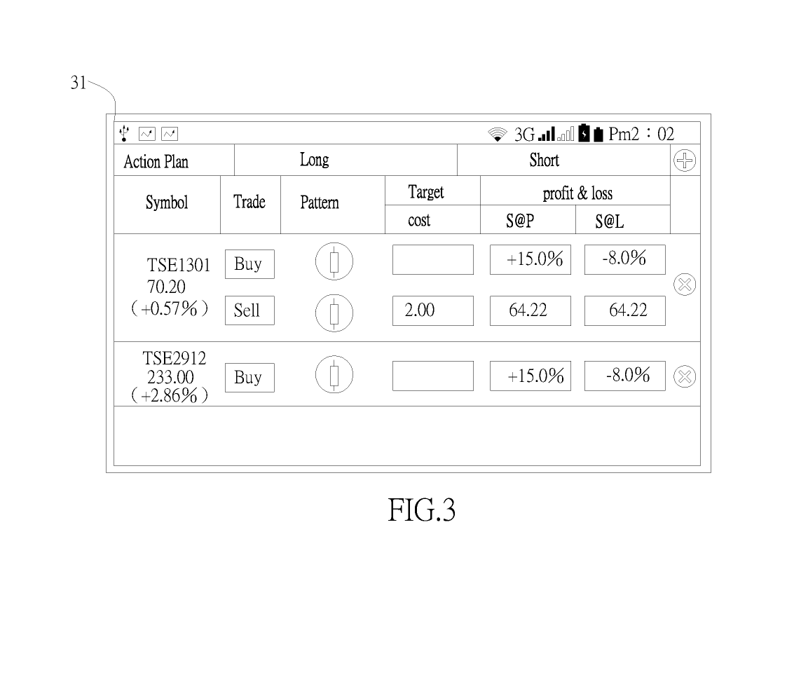

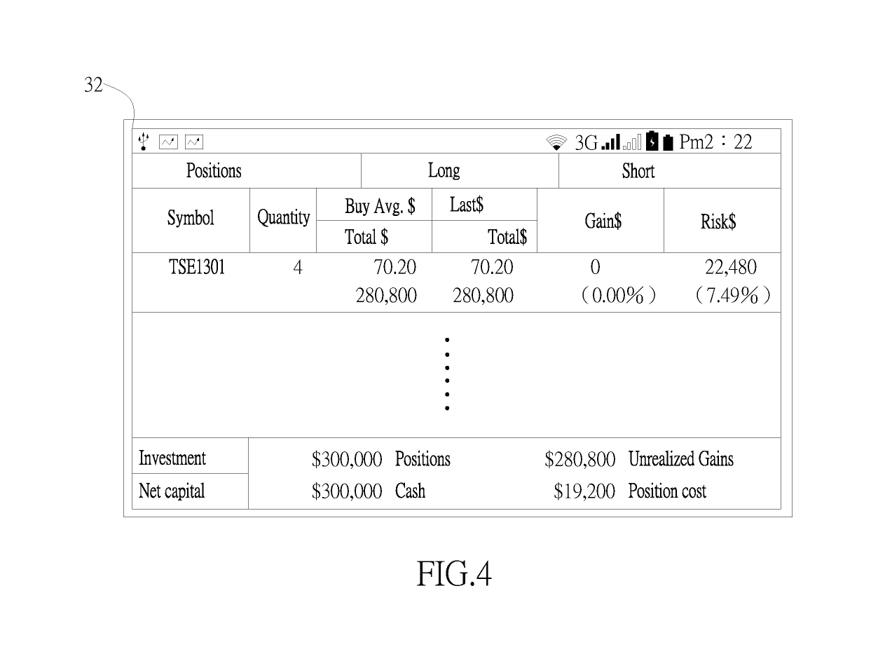

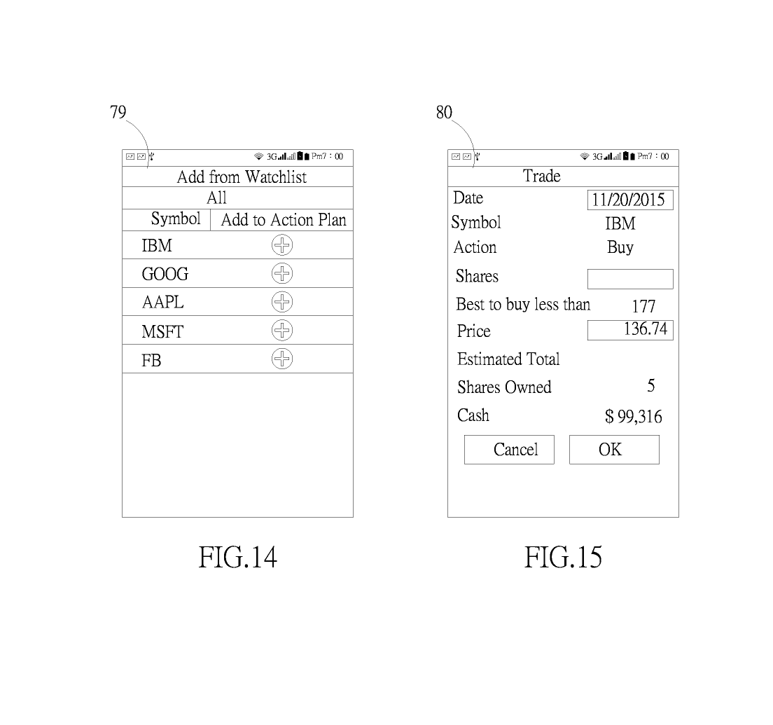

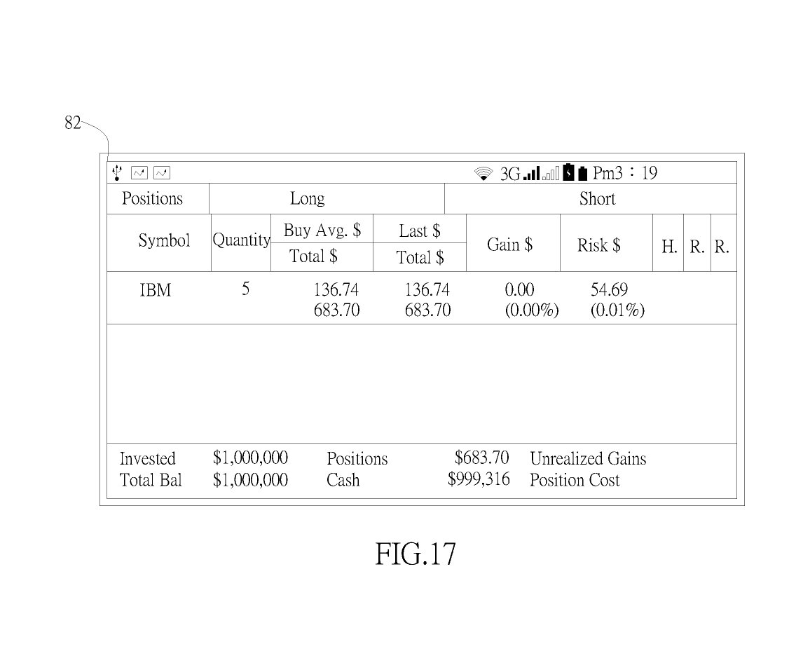

Note: Symbols of the securities and related information in FIG. 3, FIG. 4, FIG. 14, FIG. 15, and FIG. 17-FIG. 19 are quoted from, but not limited to, the listed of Taiwan Stock Exchange (TSE).

### DESCRIPTION OF THE PREFERRED EMBODIMENT

The invention disclosed herein is directed to an alerting method for assisting user in performing disciplined operations in security trading. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

In the present invention, the alerting method for assisting user in performing disciplined operations in security trading, mainly applied to a security information processing system, can help the user devoting himself/herself to performing operations in security trading to be actively alerted whether or not the trading he/she is making fulfills a predetermined trading strategy, whether or not more sale/buy shall be considered, or/and whether the instant trade is high risked and thus shall be abandoned, and thereby the user's operations would be biased from his/her preset trading strategy in security trading.

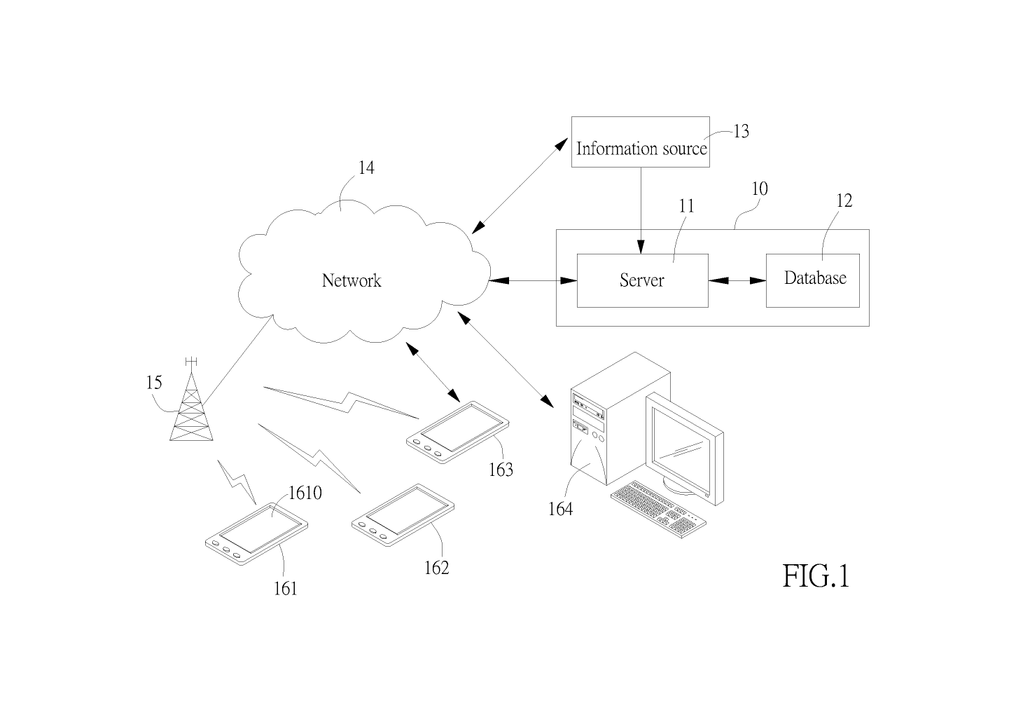

Referring now to FIG. 1, an embodiment of a security information processing system for performing an alerting method for assisting user in performing disciplined operations in security trading in accordance with the preset invention is schematically shown.

This embodiment of the security information processing system includes a server 11, at least one database 12, an information source 13, a communicative medium 14, a communicative servicing system 15, and a plurality of client devices 161, 162, 163, 164. The server 11 and the database 12 are integrally to form a security information servicing system 10. The server 11 can receive a plurality of security trading information from the at least one information source 13, perform an analysis upon the received security trading information, and then store the analytic results into the at least one database 12. The server 11 can receive connection requests from and then establish the connection with a plurality of client devices 161, 162, 163, 164 via a communicative medium 14. As the communicative connections are established, the client devices 161, 162, 163, 164 can log in the server 11 to further access the service provided by the server 11, which the service includes, but not limited to, download the trading information or static data of the security stored in the at least one database 12 from the server and so on. In the present invention, the trading information or statistic data of the security are commonly called as the security information.

The data connection among the client devices 161, 162, 163, 164, the server 11 and the information source 13 can be established by utilizing the communicative medium 14 provided by the at least one communicative servicing system 15. In this embodiment, the security information processing system 10 is to provide information service regarding the valuable securities, in which the valuable securities includes, but not limited to, stocks, futures, warrants, funds, bonds and so on. The information source 13 or sources is/are the source/sources accessible to the server 11 and the client devices 161, 162, 163, 164, and can include, but not limited to, real-time or/and historical databases provided by security exchanges, security dealers, banks, news, television and broadcast media, private enterprises and so on. The communicative servicing system 15 can be, but not limited to, GSM850/900/1800/1900, a CDMA, a WCDMA, a PHS, a GPRS, a WiMAX, an LTE and any system the like. The client devices 161, 162, 163, 164 can be, but not limited to, stock machines having a touch screen, PDAs, smart phones, the like handheld electronic devices, a tablet, notebook or desktop calculator having a touch screen. The communicative medium 14 can include at least one of a mobile-phone communicative medium, a wireless network communicative medium, and a network medium.

In the present invention, the alerting method for assisting user in performing disciplined operations in security trading is applicable to the security information processing system including the server 11 and the plurality of client devices 161, 162, 163, 164. Each of the client devices 161, 162, 163, 164 has an individual touch screen 160 and a memory for the user to operate the corresponding client device so as thereby to perform the alerting method for assisting user in performing disciplined operations in security trading. In addition, the user can also operate the client device 161, 162, 163 or 164 to perform electronic trades of securities. Generally, each individual client device 161, 162, 163 or 164 logins the server of a security broker (i.e. one of the information sources 13) through the network 14 for performing security trading electronically, for example, to buy or sell a specific volume of the security at a specific price during the open period of the exchange.

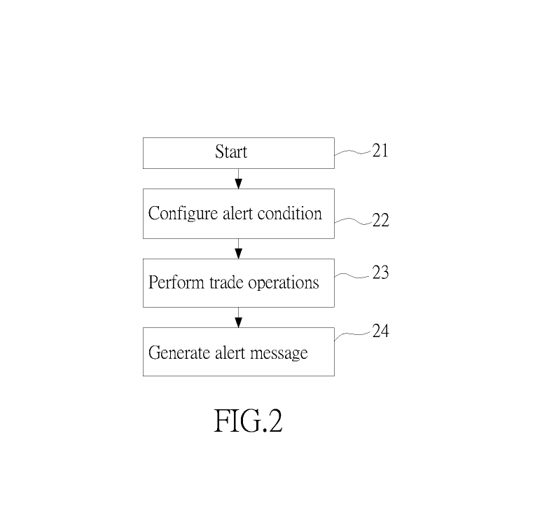

Referring now to FIG. 2, a flowchart of an embodiment of the alerting method for assisting user in performing disciplined operations in security trading in accordance with the present invention is shown. The alerting method for assisting user in performing disciplined operations in security trading includes the steps of:

Step 21: Start. The user operates the client device (for example, by touching the screen) to perform an application program related to the security trading, such that the alerting method for assisting user in performing disciplined operations in security trading of the present invention can be activated.

Step 22: Configure the alerting conditions. Through operating the client device, at least one alerting condition related to at least one the security is configured, in which the alerting condition is related to a disciplined operating rule, and the client device calculates a prime cost of the security after reading, and according to, a historical trading record of the configured security.

Step 23: Perform the trade. The client device is operated to perform the electronic trade of the security by inputting a volume and a price of the security to be traded.

Step 24: Generate an alerting message. After the volume and price for the security to be traded are input and before the electronic trade is seriously initiated, the configured alerting condition for the security at the client device and the calculated prime cost are used to determine whether or not the input volume and price for the security fulfill the disciplined operating rule defined by the alerting condition. According to the result of the determining, a corresponding alerting message is generated and further displayed on the screen of the client device so as to help the user in performing the disciplined operations.

In this embodiment, the disciplined operating rule includes a trade rule of selling high but keeping low. Namely, for the same security to be electronically traded at various timing, if a clearance is not considered, the security with positions having higher buy-in prices would be sold firstly, and the security with positions having lower buy-in prices would be kept in positions.

In this embodiment, Step 22 allows the user to operate the client device to manually configure the alerting condition. However, in another embodiment of the present invention, in Step 22, the user may choose not to perform the manual configuration, but to introduce the preset disciplined operating rule of the system, in which the disciplined operating rule for the user of the client device is enforcedly defined by the system.

In this embodiment, after the volume and price for the security to be traded are input and before the electronic trade is seriously initiated (i.e. prior to forwarding the trade to the broker), in Step 24, the alerting method of the present invention would automatically check and judge whether or not the volume and the price for the security to be traded fulfill the disciplined operations, and, according to the judgment, an alerting message is generated. In another embodiment of the present invention, in Step 23, besides the user can perform the trade, a simulated trade can also be feasible for the user to operate the client device to perform the simulated trade of the security similarly by inputting a volume and a price of the security to undergo the simulated trade. In such an application, the system would not forward the trade to the broker anyway. In this embodiment, while in performing the simulated trade, the trade information input by the user including the volume and the price for the security to be simulated can be either real or fake. In either type of data input, the system of the present invention would base on the input trade data to perform Step 24 for automatically checking and determining whether or not the input volume and price for the security to be simulated fulfill the disciplined operating rule defined by the alerting condition, and, according to the result of the determining, generating a corresponding alerting message.

In one embodiment of the present invention, the alerting message further includes at least one of following two steps.

Step (C1): when the electronic trade is to sell the security and the result of the determining confirms that the disciplined operations are met, the alerting message to be displayed including:

If sale price>prime cost of current sale volume,
displaying “in this position of sale, profits realized are positive”;

If sale price>prime cost of current open-position volume,
displaying “after this sale, unrealized profits in positions are positive”; and

If the aforesaid two conditions are met simultaneously,
displaying additionally “Your buy strategy basically satisfies the price-raising rule”; and

Step (C2): when the electronic trade is to sell the security and the result of the determining confirms that the disciplined operations are not met, the alerting message to be displayed including:

If sale price<prime cost of current sale volume,
displaying “in this position of sale, profits realized are negative, and more sale shall be considered”, and simultaneously a functional button “more sale” being displayed below the alerting message;

If sale price<prime cost of current open-position volume,
displaying “after this sale, unrealized profits in positions are negative, and a clearance shall be considered”, and simultaneously a functional button “clearance” being displayed below the alerting message he alerting message; clicking the “clearance” functional button leading directly to display a volume in positions;

If the aforesaid two conditions are met simultaneously,
displaying additionally “Your buy strategy is a downward amortization, a high-risk operation”.

Hence, prior to a real security trading, the user can have the alerting message provided automatically by the alerting method of the present invention, such that a more relevant buy/sell strategy can be adjusted arbitrarily.

In this embodiment, the disciplined operating rule includes a stop gain/stop loss calculation rule with respect to the security, the stop gain/stop loss calculation rule including the following algorithms:

algorithms 1: stop gain price=prime cost×stop interest, wherein the stop interest is a preset value of 1.15;

algorithms 2: stop price=prime cost×loss ratio, wherein the loss ratio is a preset value of 0.92;

and, wherein the alerting method includes a daily auto-calibration process upon the stop gain/stop loss calculation rule, the daily auto-calibration process including:
calibration rule 1: when close price of the security≧stop gain price of the security,
   if the close price×loss ratio≧previous stop price, the daily stop price of the security=close price×loss ratio;
   if the close price×loss ratio<previous stop price, the daily stop price of the security being kept unchanged;
calibration rule 2: as the daily stop price is updated,
   if the daily stop price>stop gain price, updating the daily stop gain price=stop price, namely the stop gain price and the stop price being the same;

wherein the alerting method displays the updated stop gain price and stop price on the screen of the client device.

In this embodiment, the disciplined operating rule includes a risk exposure amount calculation rule with respect to the security, the risk exposure amount calculation rule including the following algorithms:
calibration rule 3: when the current price of the security≧stop price,
   If prime cost≧stop price, then risk exposure amount=prime cost−stop price; and
   If prime cost<stop price, then risk exposure amount=0; and
calibration rule 4: when the current price of the security<stop price,
   If current price<prime cost×loss ratio, then risk exposure amount=prime cost−current price; and
   If current price≧prime cost×loss ratio, then risk exposure amount=prime cost−prime cost×loss ratio;

wherein the stop price is obtained according to the daily auto-calibration process upon the stop gain/stop loss calculation rule;

wherein the alerting method displays the calculated risk exposure amount on the screen of the client device.

In one embodiment of the present invention, the disciplined operating rule further includes a risk-alerting function with respect to the security, wherein, if the risk exposure amount exceeds 2% of the assets equity, a warning of the risk of the security being too high is displayed on the screen of the client device. Upon such an arrangement, the user may always understand if the instant security trading is under high risk, an so an in-time adjustment can be introduced anytime to reduce the possible investment risk.

Referring now to FIG. 3, a first embodiment of a display on the screen of the client device in the alerting method for assisting user in performing disciplined operations in security trading in accordance with the present invention is shown. According to the alerting method of the present invention, the display 31 on the screen of the client device can include a column of “Action Plan” to alert the user that the alerting method for assisting user in performing disciplined operations in security trading is in action. Besides, the screen further includes the following columns.

Functional buttons “long” and “short” stand for whether the user-concerned security is long or short, respectively. In this embodiment, “long” and “short” are two different functional buttons to be clicked for entering pages and contents of long objects and short objects, respectively. In particular, the user can use the interface shown in FIG. 14 to enter the long or short security.

Under the column “symbol”, the symbol, the instant pricing and real-time trend for the security are included.

Under the column “trade”, virtual functional buttons “buy” and “sell” for individual security are included. By clicking each of the functional buttons, the display can be switched into a next display for the security to trade.

Under the column “pattern”, alerting diagrams for each individual security are included, in which each of the alerting diagrams stands for specific long or short pattern visually for the user to aware in an instinct way the attributes or technical indices for the concerned security.

The columns “target” and “cost” stand for the target price and the prime cost of each individual security, respectively.

Under the column “profit & loss”, the stop gain price (by additional 15% of the prime cost) and the stop price (by subtracting 8% of the prime cost) for each individual security are included.

Referring now to FIG. 4, a second embodiment of a display on the screen of the client device in the alerting method for assisting user in performing disciplined operations in security trading in accordance with the present invention is shown. In the display 32 on the screen of the client device according to the alerting method of the present invention, a column “Positions” is included to display the quantity, the buy-in average (total cost), the estimated profit (or profit percentage) and the risk exposure amount (or percentage) calculated based on the instant pricing for each in-position security. Also, the related investment, assets equity, holding positions, cash flows, unrealized profits, in-stock cost and so on can be included.

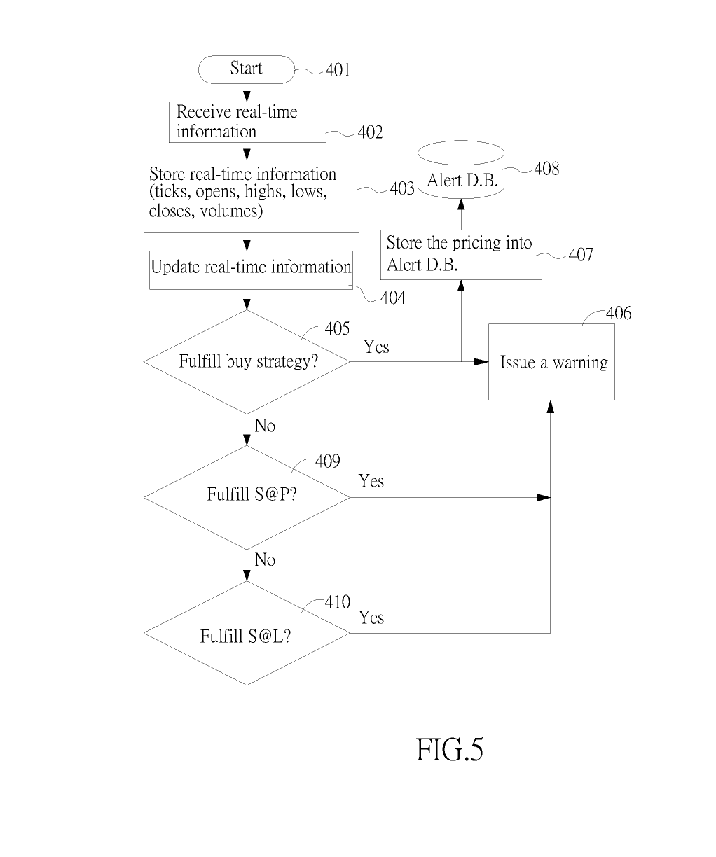

Referring now to FIG. 5, a flowchart of a process of information receiving and alerting for the alerting method for assisting user in performing disciplined operations in security trading in accordance with the present invention is shown. The process includes the steps of:

Step 401: Start the alerting method by operating the client device.

Step 402: The client device goes through the network to receive real-time information related to the security trading from the information source (for example, but not limited to, the broker or the security firm).

Step 403: The client device stores the received real-time information including trade details, ticks, opens, highs, lows, closes, volumes and the related data of each security into the memory of the client device.

Step 404: Update the real-time information with the time, such that the client device can arrange the capturing of the updated security information from the information source.

Step 405: Check if the received real-time information includes a clue that the trading strategy for buying/selling the security configured by the user has been fulfilled; namely, to check if the configured alerting condition has been met? If positive, perform Step 406 and Step 407. Otherwise, perform Step 409.

Step 406: Issue a warning (i.e. generate an alerting message). For example, if the client device is a mobile phone, the warning can be listed top to the screen by accompanying an alerting ring. Then, go back to Step 404 or end the method.

Step 407: Store the pricing information associating a reach of the alerting condition into the database 408 (Alert D.B.) of the client device.

Step 409: Check the new trading price and see if the price can meet a user-configured profit (Sell at profit, so-called S@P). if positive, perform Step 406 and Step 407. Otherwise, perform Step 410.

Step 410: Check the new trading price and see if the price can meet a user-configured loss (Sell at lost, so-called S@L). if positive, perform Step 406 and Step 407. Otherwise, go back to Step 404 or end the method.

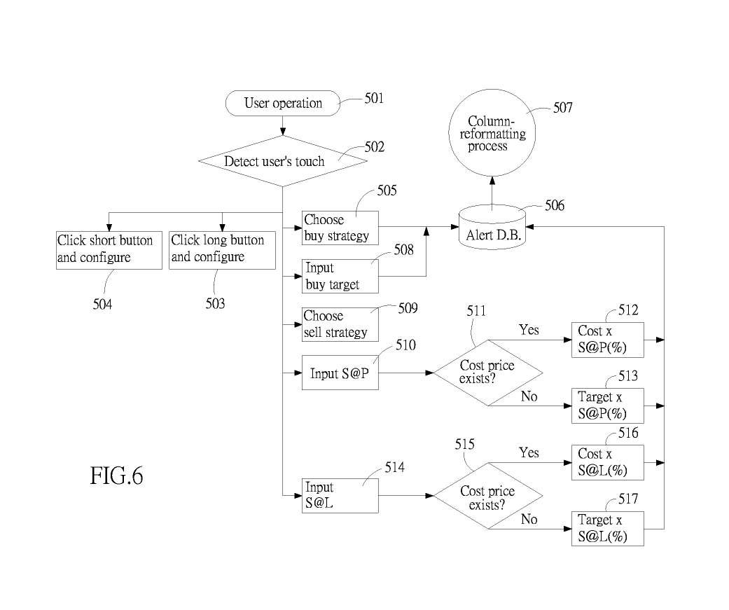

Referring now to FIG. 6, a flowchart of a process of user's operations for the alerting method for assisting user in performing disciplined operations in security trading in accordance with the present invention is shown. The process includes the following steps.

Step 501: The user begins to operate the client device to perform the alerting method for assisting user in performing disciplined operations in security trading.

Step 502: Detect user's touch. The client device detects if or not the user input an operational command by touching the touch screen, and bases on the command to perform one of Step 503, 504, 505, 508, 509, 510 and 514.

Step 503: The client device detects that the long button is clicked, and so the alerting method of the present invention is set to be long-ward.

Step 504: The client device detects that the short button is clicked, and so the alerting method of the present invention is set to be short-ward.

Step 505: The client device detects that the user clicks a function of either the buy strategy or the sell strategy, and so Step 506 is performed to connect the alert database (Alert D.B.) of the client device.

Step 506: Connect the alert database (Alert D.B.) of the client device so as to write or retrieve data, and then perform Step 507.

Step 507: The client device bases on the detection of Step 502 (user's operational command and the alert data from the alert database to perform column-reformatting process, namely to update the content of the display.

Step 508: The client device detects that the user clicks the buy-in price or buy-in target function of the buy strategy, and thus performs Step 506 to connect the alert database (Alert D.B.) of the client device.

Step 509: The client device detects that the user clicks the sell strategy, and thus performs Step 506 to connect the alert database (Alert D.B.) of the client device.

Step 510: The client device detects that the user clicks the input of the profit percentage function for the S@P, and thus performs Step 511.

Step 511: Detect if there is data of prime cost or trade price. If positive, perform Step 512. Otherwise, perform Step 513.

Step 512: Base on the prime cost and the profit percentage to calculate the S@P, and then performs Step 506.

Step 513: Base on the target price and the profit percentage to calculate the S@P, and then performs Step 506.

Step 514: The client device detects that the user clicks the function for inputting the loss percentage of the S@L, and then performs Step 515.

Step 515: Detect if there is data of prime cost or trade price. If positive, perform Step 516. Otherwise, perform Step 517.

Step 516: Base on the prime cost and the loss percentage to calculate the S@L, and then performs Step 506.

Step 517: Base on the target price and the loss percentage to calculate the S@L, and then performs Step 506.

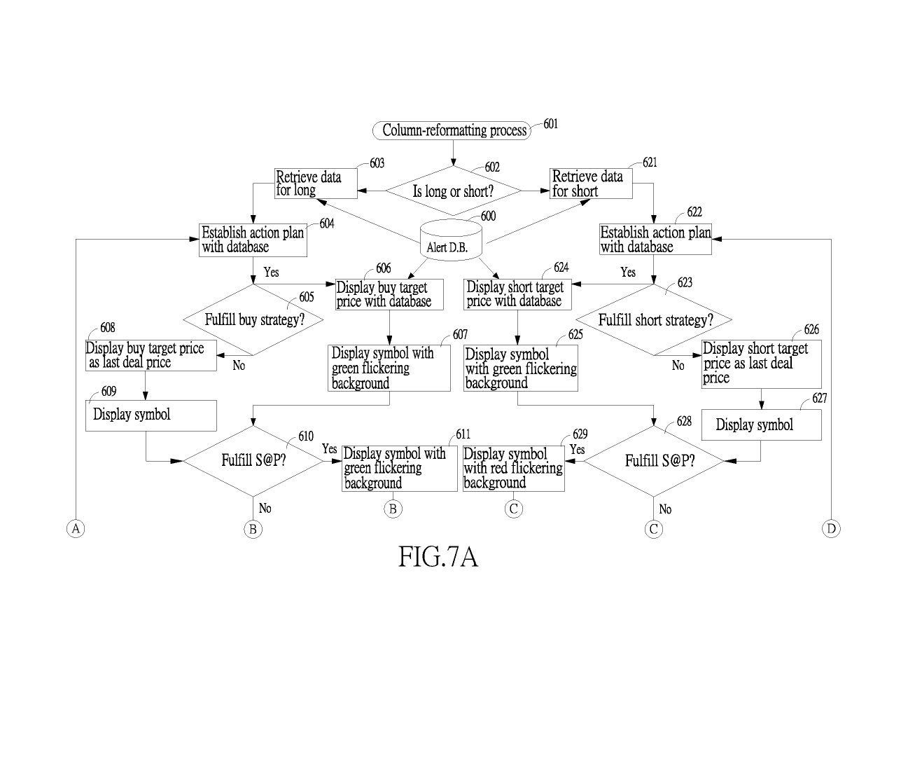

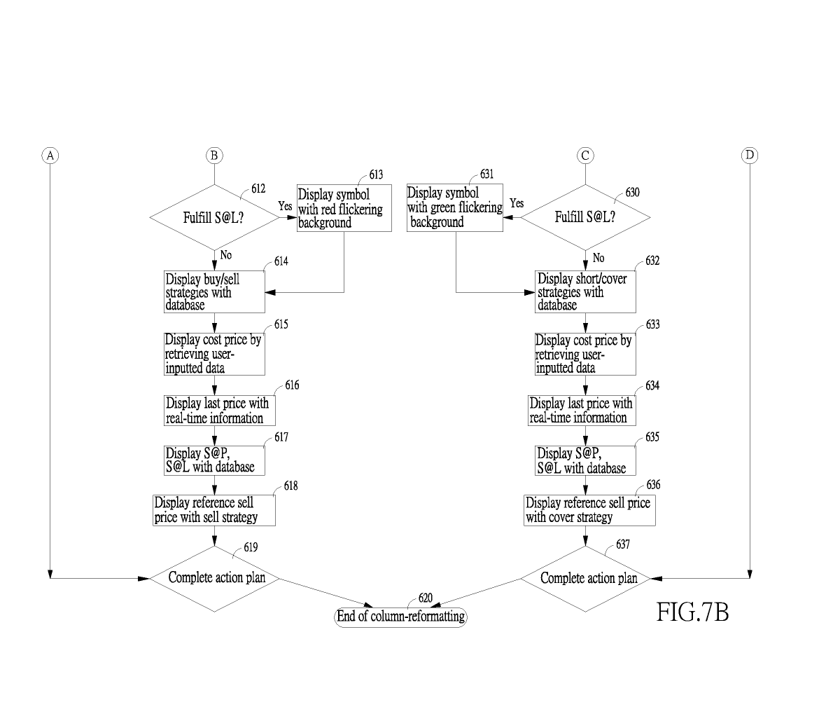

Referring now to both FIG. 7A and FIG. 7B, a flowchart of a process of window reformatting for the alerting method for assisting user in performing disciplined operations in security trading in accordance with the present invention is integrally shown. The process includes the following steps.

Step 601: The user begins to operate the client device to perform the alerting method for assisting user in performing disciplined operations in security trading, and initiates the column-reformatting process.

Step 602: Detect if the user's operational command is the long-ward operation or the short-ward operation. If the long-ward operation, then perform Step 603. If the short-ward operation, then perform Step 621.

Step 603: Connect to the alert database (Alert D.B.) 600 of the client device so as to retrieve the long-ward data in the columns of the long-ward settings, and then perform Step 604.

Step 604: Base on the data from the database to establish following items for further defining an action plan, and then perform Step 605.

Step 605: Check if the newest trade price from the information source reaches the user-configured buy-in condition of the buy strategy. If positive, then perform Step 606. Otherwise, perform Step 608.

Step 606: Retrieve related data from the database 600, and base on the data of the database 600 to display the buy-in target price, and then perform Step 607.

Step 607: Base on the data retrieved from the database to display the symbol of the security, particularly with a green flickering background, and then perform Step 610.

Step 608: Base on the last deal price to display the buy-in target price, and then perform Step 609.

Step 609: Base on the data retrieved from the database to display the symbol of the security.

Step 610: Check if the newest trade price reaches the user-configured S@P. If positive, then perform Step 611. If negative, the perform Step 612.

Step 611: Display the symbol of the security with a green flickering background.

Step 612: Check if the newest trade price reaches the user-configured S@L. If positive, then perform Step 613. If negative, the perform Step 614.

Step 613: Display the symbol of the security with a red flickering background.

Step 614: Base on the data retrieved from the database to display buy and sell strategies for the security, and then perform Step 615.

Step 615: Base on the data retrieved from the database and the inputted price by the user to display the prime cost or the trade price, and then perform Step 616.

Step 616: Base on the received real-time information to display the newest trade price in the market, and then perform Step 617.

Step 617: Base on the data retrieved from the database to display the stop gain price and the stop price, and then perform Step 618.

Step 618: Base on the price defined by the sell strategy to display a reference sell price, and then perform Step 619.

Step 619: After the action plan has been established, perform Step 620.

Step 620: End of the column-reformatting.

Step 621: Connect to the alert database (Alert D.B.) 600 of the client device so as to retrieve the short-ward information from related columns, and then perform Step 622.

Step 622: Base on the data from the database to establish a follow-up action plan, and then perform Step 623.

Step 623: Check if the newest trade price of the security retrieved from the information source fulfills the user-configured trading strategy. While in short selling, the method will check if a short selling strategy configured by the user has been fulfilled. If positive, then perform Step 624. Otherwise, perform Step 626.

Step 624: Retrieve related data from the database 600, base on the data of the database 600 to display the target price for short selling, and then perform Step 625.

Step 625: Base on the data retrieved from the database to display the symbol of the security with a green flickering background, and then perform Step 628.

Step 626: Base on the last deal price to display a target price for short selling, and then perform Step 627.

Step 627: Base on the data retrieved from the database to display the symbol of the security, and then perform Step 628.

Step 628: Check if the newest trade price reaches the user-configured S@P. If positive, then perform Step 629. Otherwise, perform Step 630.

Step 629: Display the symbol of the security with a red flickering background.

Step 630: Check if the newest trade price reaches the user-configured S@L. If positive, then perform Step 631. Otherwise, perform Step 632.

Step 631: Display the symbol of the security with a green flickering background.

Step 632: Base on the data from the database to display short selling and covering strategy for the security, and then perform Step 633.

Step 633: Base on the data retrieved from the database and the price inputted by the user to display the prime cost or the trade price, and then perform Step 634.

Step 634: Base on the received real-time information to display the newest trade price in the market, and then perform Step 635.

Step 635: Base on the data retrieved from the database to display the stop gain price and the stop price, and then perform Step 636.

Step 636: Base on the price accomplished by the covering strategy to display a reference sell price, and then perform Step 637.

Step 637: After the action plan is completed, perform Step 620.

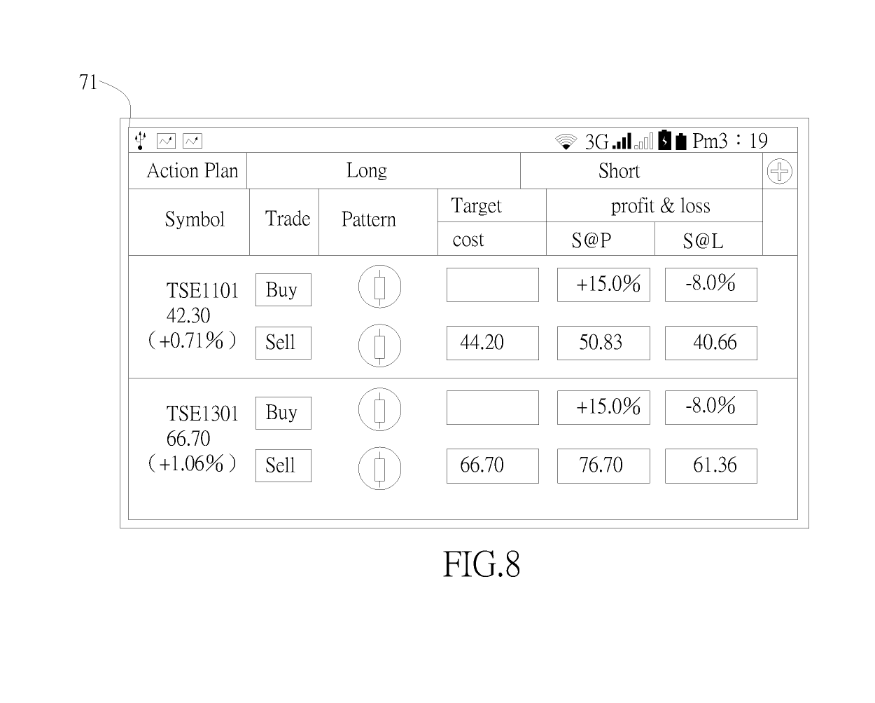

Referring now to FIG. 8, a third embodiment of a display on the screen of the client device in the alerting method for assisting user in performing disciplined operations in security trading in accordance with the present invention is schematically shown. When a trade alert function of the alerting method in accordance with the present invention is performed, the display 71 as shown in FIG. 8 includes a column of “Action Plan”.

The “Action Plan” column on the display of the screen of the client device according to the alerting method of the present invention is to alert the user the current state of the method. Also, the screen further includes the following columns.

The columns “long” and “short” stand for the long securities and the short securities, respectively.

The column “symbol” lists thereunder the symbol of the security, the real-time price and the real-time variation.

Under the column “trade”, virtual buy/sell functional buttons for each individual security are shown. By clicking any of the aforesaid functional buttons, the display can be switched to another state of trading the security.

Under the column “pattern”, various plots for alerting are listed to account for specific alert functions. Through the visualized alert types, the alert functions thereabout can be easily taken by the user in a straight-forward manner.

The columns “target” and “cost” stand for the target price and the prime cost of the security, respectively.

Under the column “Profit & Loss”, the stop gain price of an additional 15% of the prime cost and the stop price by subtracting 8% of the prime cost for the security are included.

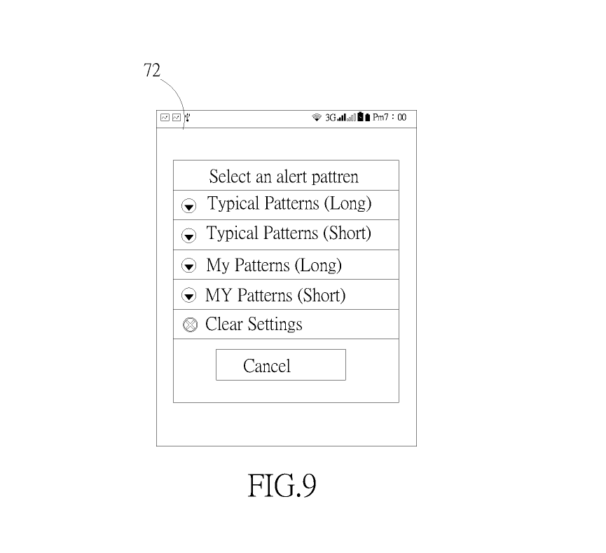

Referring now to FIG. 9, a fourth embodiment of a display on the screen of the client device in the alerting method for assisting user in performing disciplined operations in security trading in accordance with the present invention is schematically shown. In the display 72 of this embodiment, when the method is to configure the alert types (either long or short), options of long and short present in the system can be provided for the user to choose, the user can configure the alert types by himself/herself, or the user can choose to make no changes upon the alert types.

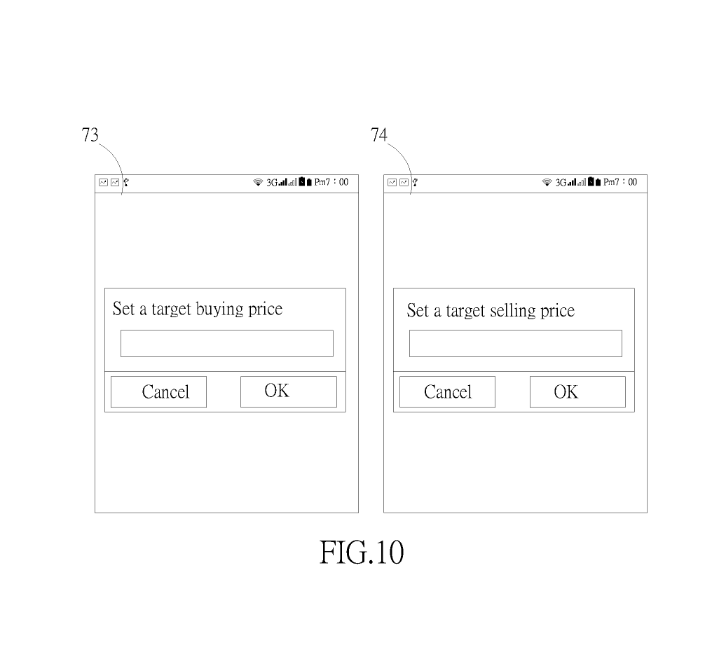

Referring now to FIG. 10, a fifth embodiment of a display on the screen of the client device in the alerting method for assisting user in performing disciplined operations in security trading in accordance with the present invention is schematically shown. In the displays 73, 74 of this embodiment, when the method is to configure the alert types (either long or short), the target price of the security for buy-in or short selling can be configured by the user.

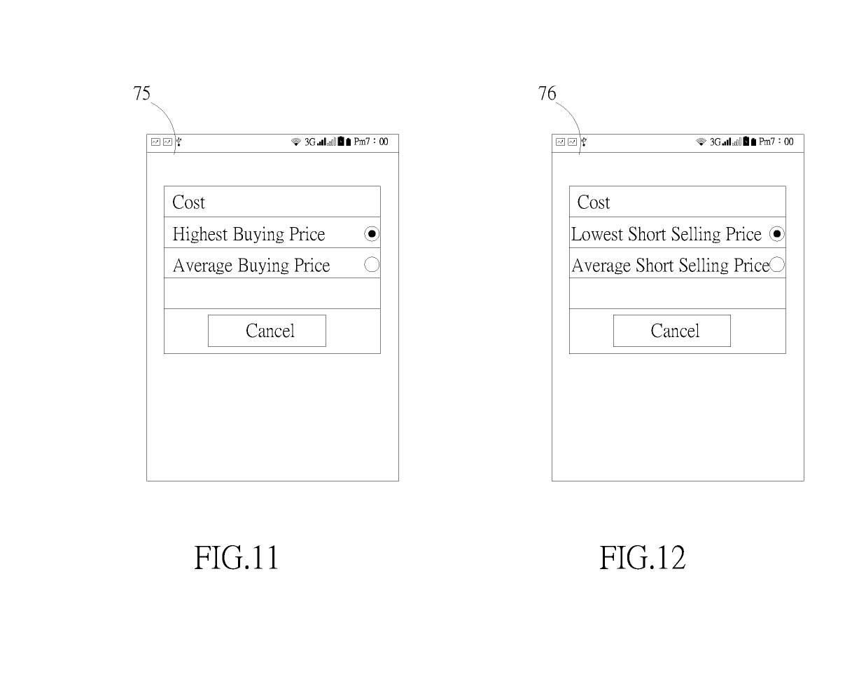

Referring now to FIG. 11, a sixth embodiment of a display on the screen of the client device in the alerting method for assisting user in performing disciplined operations in security trading in accordance with the present invention is schematically shown. In the display 75 of this embodiment, when the method is to perform long operations, the user can set a highest buying price or an average buying price as the prime cost for the security. In the default of the system, the highest buying price is used as the prime cost for the security for calculating the stop at loss and the stop gain price, such that the alert point cannot be deviated too much.

Referring now to FIG. 12, a seventh embodiment of a display on the screen of the client device in the alerting method for assisting user in performing disciplined operations in security trading in accordance with the present invention is schematically shown. In the display 76 of this embodiment, when the method is to perform short operations, the user can set a lowest short selling price or an average short selling price as the prime cost for the security. In the default of the system, the lowest short selling price is used as the prime cost for the security for calculating the stop at loss and the stop gain price, such that the alert point cannot be deviated too much.

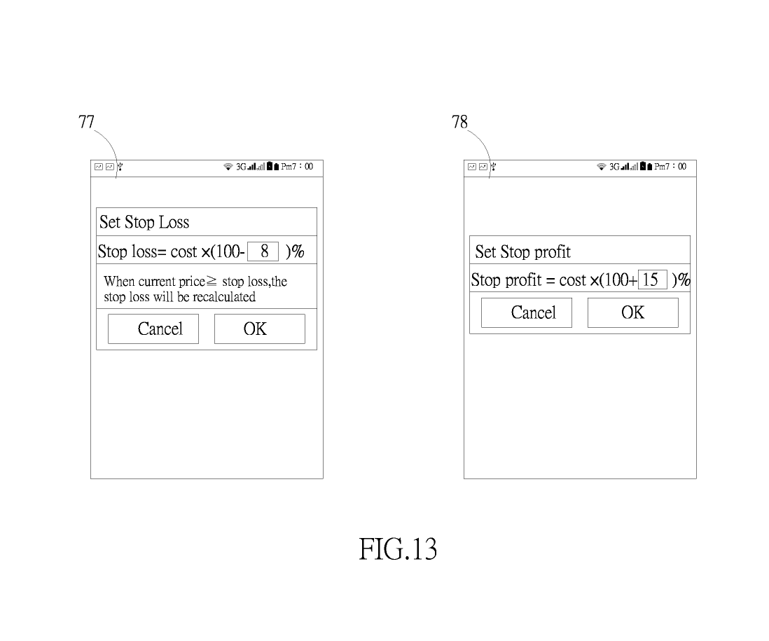

Referring now to FIG. 13, an eighth embodiment of a display on the screen of the client device in the alerting method for assisting user in performing disciplined operations in security trading in accordance with the present invention is schematically shown. In the displays 77, 78 of this embodiment, while in configuring the stop loss price and the stop profit price, the percentage of the prime cost to be added to the stop loss price and that thereof to be subtracted from the prime cost for the stop profit price are options of the user. In the default of the system, they are 15% and 8%, respectively.

Referring now to FIG. 14, a ninth embodiment of a display on the screen of the client device in the alerting method for assisting user in performing disciplined operations in security trading in accordance with the present invention is schematically shown. In the display 79 of this embodiment, the user can arbitrarily add the securities from the favorite securities into the trade-alert watchlist.

Referring now to FIG. 15, a tenth embodiment of a display on the screen of the client device in the alerting method for assisting user in performing disciplined operations in security trading in accordance with the present invention is schematically shown. In the display 80 of this embodiment, when a specific security is to trade, columns are available for receiving the user-configured volume and price for the security, and also, the system would calculate the available funds and the in-position volume of the security for the use. The present invention would directly display the proposed volume to be traded, and such a trading proposal is based on the aforesaid calculation of the “stop gain/stop loss calculation rule” in accordance with the present invention.

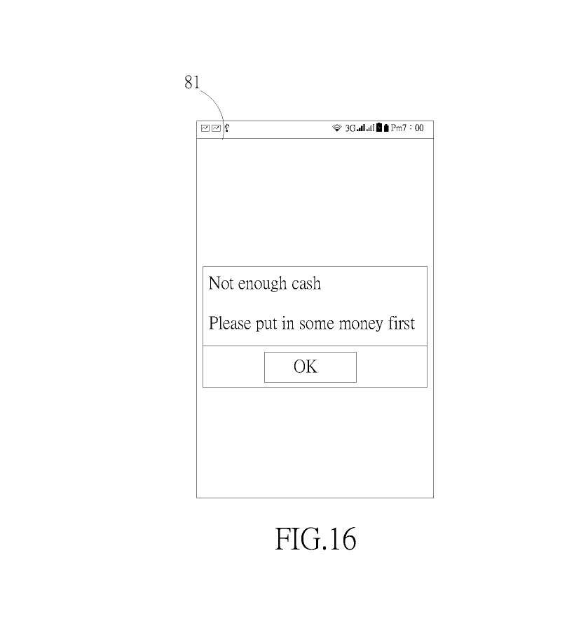

Referring now to FIG. 16, an eleventh embodiment of a display on the screen of the client device in the alerting method for assisting user in performing disciplined operations in security trading in accordance with the present invention is schematically shown. In the display 81 of this embodiment, when a specific security is to be bought but no sufficient cash are met, the alerting method of the present invention would alert the user to add more money so as not to damage the contract.

Referring now to FIG. 17, a twelfth embodiment of a display on the screen of the client device in the alerting method for assisting user in performing disciplined operations in security trading in accordance with the present invention is schematically shown. In the display 82 of this embodiment, the average price and the total cost for buying or short selling, current price and the current value, profit or loss amount and percentage, and the risk exposure amount and percentage for the security would be displayed as well for the user to easily evaluate.

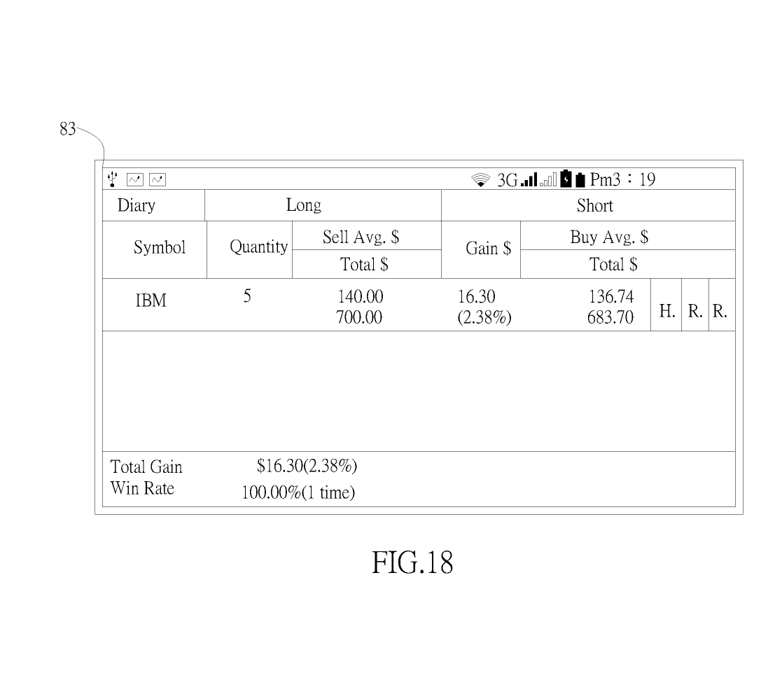

Referring now to FIG. 18, a thirteenth embodiment of a display on the screen of the client device in the alerting method for assisting user in performing disciplined operations in security trading in accordance with the present invention is schematically shown. In the display 83 of this embodiment, details of the sale quantity, the average sell price, the total trade, profit/loss amount and percentage, and the average cost and amount for the traded security can also be displayed for the user to record and evaluate.

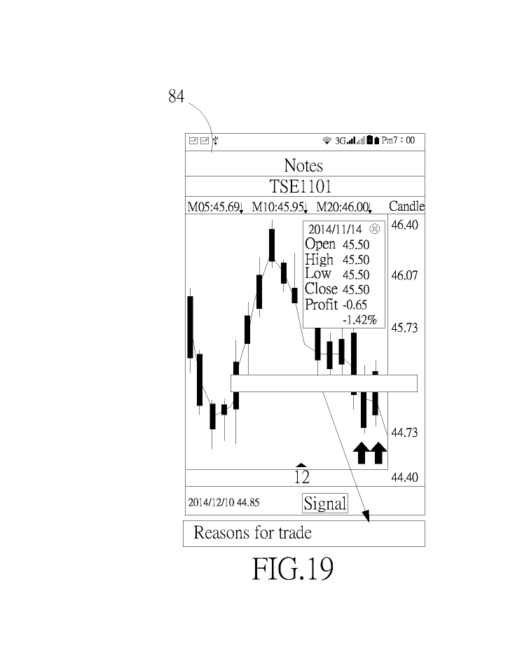

Referring now to FIG. 19, a fourteenth embodiment of a display on the screen of the client device in the alerting method for assisting user in performing disciplined operations in security trading in accordance with the present invention is schematically shown. In the display 84 of this embodiment, the method can also allow the user to operate the historical technical plots by pointing out or labeling the trading points. When the user clicks any of the points, an input window on the display would appear for the user to input any note such as the reason for trade and any the like.

While the present invention has been particularly shown and described with reference to a preferred embodiment, it will be understood by those skilled in the art that various changes in form and detail may be without departing from the spirit and scope of the present invention.

What is claimed is:

1. An alerting method for assisting user in performing disciplined operations in security trading, applied to a security information processing system including a server and at least one client device, the server capturing a plurality of trading information of a plurality of securities from a foreign information source and storing the plurality of trading information into a database, the at least one client device being able to be used to perform an electronic trade or a simulated trade (the trade) upon the securities; the alerting method comprising the steps of:
Step (A): configuring at least one alerting condition of at least one said security in the client device, the alerting condition being associated with a disciplined operating rule, the client device reading a historical trading record relative to the security, according to the historical trading record to calculate a prime cost of the security; wherein the configuring of the at least one alerting condition is achieved by operating the client device to perform setup or to recall the preset alerting condition stored in the client device;
Step (B): operating the client device to perform the trade upon the security, and inputting a volume and a price of the security to be traded; and
Step (C): after the volume and the price of the security to be traded are set up, and before the trade is seriously performed, the client device basing on the configured alerting condition of the security and the calculated prime cost to determine whether the input volume and price of the security meet a disciplined operating rule defined by the alerting condition, and then basing on a result of the determining to generate an alerting message to be displayed on a screen of the client device so as to help a user to perform related disciplined operations.

2. The alerting method for assisting user in performing disciplined operations in security trading of claim 1, wherein the disciplined operating rule includes a trade rule of selling high but keeping low; namely, for the same security to be electronically traded at various timing, if a clearance is not considered, the security with positions having higher buy-in prices being sold firstly, and the security with positions having lower buy-in prices being kept in positions.

3. The alerting method for assisting user in performing disciplined operations in security trading of claim 2, wherein, in the Step (C), the alerting message further includes one of following two steps:
Step (C1): when the electronic trade is to sell the security and the result of the determining confirms that the disciplined operations are met, the alerting message to be displayed including:
if sale price>prime cost of current sale volume,
displaying “in this position of sale, profits realized are positive”;
if sale price>prime cost of current open-position volume,
displaying “after this sale, unrealized profits in positions are positive”; and
if the aforesaid two conditions are met simultaneously,
displaying additionally “Your buy strategy basically satisfies the price-raising rule”; and
Step (C2): when the electronic trade is to sell the security and the result of the determining confirms that the disciplined operations are not met, the alerting message to be displayed including:
if sale price<prime cost of current sale volume,
displaying “in this position of sale, profits realized are negative, and more sale shall be considered”, and simultaneously a functional button “more sale” being displayed below the alerting message;
if sale price<prime cost of current open-position volume,
displaying “after this sale, unrealized profits in positions are negative, and a clearance shall be considered”, and simultaneously a functional button “clearance” being displayed below the alerting message he alerting message; clicking the “clearance” functional button leading directly to display a volume in positions;
if the aforesaid two conditions are met simultaneously,
displaying additionally “Your buy strategy is a downward amortization, a high-risk operation”.

4. The alerting method for assisting user in performing disciplined operations in security trading of claim 1, wherein the disciplined operating rule includes a stop gain/stop loss calculation rule with respect to the security, the stop gain/stop loss calculation rule including the following algorithms:
algorithms 1: stop gain price=prime cost×stop interest, wherein the stop interest is a preset value of 1.15;
algorithms 2: stop price=prime cost×loss ratio, wherein the loss ratio is a preset value of 0.92;
and, wherein the alerting method includes a daily auto-calibration process upon the stop gain/stop loss calculation rule, the daily auto-calibration process including:
calibration rule 1: when close price of the security≧stop gain price of the security,
if the close price×loss ratio≧previous stop price, the daily stop price of the security=close price×loss ratio;
if the close price×loss ratio<previous stop price, the daily stop price of the security being kept unchanged;
calibration rule 2: as the daily stop price is updated,
if the daily stop price>stop gain price, updating the daily stop gain price=stop price, namely the stop gain price and the stop price being the same;
wherein the alerting method displays the updated stop gain price and stop price on the screen of the client device.

5. The alerting method for assisting user in performing disciplined operations in security trading of claim 4, wherein the disciplined operating rule includes a risk exposure amount calculation rule with respect to the security, the risk exposure amount calculation rule including the following algorithms:
calibration rule 3: when the current price of the security≧stop price,
if prime cost≧stop price, then risk exposure amount=prime cost−stop price; and
if prime cost<stop price, then risk exposure amount=0; and
calibration rule 4: when the current price of the security<stop price,
if current price<prime cost×loss ratio, then risk exposure amount=prime cost−current price; and
if current price≧prime cost×loss ratio, then risk exposure amount=prime cost−prime cost×loss ratio;
wherein the stop price is obtained according to the daily auto-calibration process upon the stop gain/stop loss calculation rule;
wherein the alerting method displays the calculated risk exposure amount on the screen of the client device.

6. The alerting method for assisting user in performing disciplined operations in security trading of claim 5, wherein the disciplined operating rule further includes a risk-alerting function with respect to the security, wherein, if the risk exposure amount exceeds 2% of the assets equity, a warning of the risk of the security being too high is displayed on the screen of the client device.
